(19) United States
(12) Patent Application Publication
(10) Pub. No.: US 2025/0217247 A1
(43) Pub. Date: Jul. 3, 2025

(54) TRACE-BASED TESTING WITH SOFTWARE ACCESS POINTS

(71) Applicant: Signature IP Corporation, Milpitas, CA (US)

(72) Inventors: Shivam Mehra, New Delhi (IN); Kishore Mishra, Santa Clara, CA (US); Parag Bhatt, San Jose, CA (US)

(73) Assignee: Signature IP Corporation, Milpitas, CA (US)

(21) Appl. No.: 19/002,836

(22) Filed: Dec. 27, 2024

Related U.S. Application Data
(60) Provisional application No. 63/688,925, filed on Aug. 30, 2024.
(60) Provisional application No. 63/663,205, filed on Jun. 24, 2024.
(60) Provisional application No. 63/643,941, filed on May 8, 2024.
(60) Provisional application No. 63/551,091, filed on Feb. 8, 2024.
(60) Provisional application No. 63/617,823, filed on Jan. 5, 2024.
(60) Provisional application No. 63/615,862, filed on Dec. 29, 2023.

(51) Int. Cl. G06F 11/22; G06F 11/27

(52) U.S. Cl. CPC G06F 11/2268; G06F 11/27

(57) ABSTRACT

Testing techniques are disclosed. A test environment is accessed. The test environment includes a trace encoder and a software device-under-test interface (SDI). The SDI is coupled to a device-under-test (DUT). Software access points are inserted into the SDI to allow observability of one or more internal signals within the SDI. Modification instructions that cause the SDI to autonomously alter a response to the DUT are programmed into the SDI. The modification instructions are based on a test instruction set architecture. A test sequence is sent to the SDI, causing communications with the device under test. Replies are received from the DUT. The SDI responds to the replies and sends additional communications to the device under test. Additional replies are obtained from the DUT. A trace encoder creates a logic trace comprised of the states of the software access points.

### RELATED APPLICATIONS

This application claims the benefit of U.S. provisional patent applications “Trace-Based Testing With Software Access Points” Ser. No. 63/615,862, filed Dec. 29, 2023, “Round Robin Bus Arbitration With Control Vectors and Increment And Decrement Functions”, Ser. No. 63/617,823, filed Jan. 5, 2024, “Weighted Round Robin Bus Arbitration With Control Vectors And Increment And Decrement Functions” Ser. No. 63/551,091, filed Feb. 8, 2024, “Coupling Network-On-Chip Sub-Topologies With Derivative Clocks” Ser. No. 63/643,941, filed May 8, 2024, “Cloud-Native Network-On-Chip Validation With Sub-Topologies” Ser. No. 63/663,205, filed Jun. 24, 2024, and “Cloud-Native Network-On-Chip Validation Including Sub-Topologies” Ser. No. 63/688,925, filed Aug. 30, 2024.

Each of the foregoing applications is hereby incorporated by reference in its entirety.

### FIELD OF ART

This application relates generally to electronics and more particularly to trace-based testing with software access points.

### BACKGROUND

Whether a product is given as a gift or purchased for a specific purpose, quality matters to most people who use or sell products. Especially as competition increases, quality can be a key factor in making a purchase or usage decision. Levels of quality can vary and can range from poor to excellent. While excellent quality is generally desirable, meeting high standards can require significant cost. These costs can include delivery schedules, longer manufacturing times, additional testing, superior materials, and so on. To avoid excess costs, quality that is sufficient to meet a specific demand can be an appropriate objective in product selection.

Some manufactured or processed products are intended to be consumed as food. Grocery store owners clearly understand that the reputation earned by the sale of poor quality foodstuffs is not conducive to business longevity. They avoid such products and seek to sell products that have the perception of being of good or excellent quality that will foster satisfied customers. Quality is also related to aspects of safety. Safe consumption of foodstuffs is of great importance to a store owner and to society in general. Grocery store owners desire happy and loyal customers. Restaurant owners likewise are interested in perceptions of quality. Quality of food, quality of food preparation, ambiance, service, and customer experience are all combined to produce delighted customers and bring future business.

Quality is of interest to manufacturers of products such as electronic devices that are intended for homes and businesses. Customers who purchase such devices want the devices to work correctly and last for a long time. Quality is necessary in products that are employed in hazardous locations such as in chemical manufacturing facilities. An example is an illumination apparatus in which the internal construction must provide a sufficient level of thermal insulation and a gas-tight seal to avoid damaging internal corrosion, while preventing contamination of the outside chemical manufacturing process. Selection of materials, design, manufacturing processes, and stress tests can play a key role in the final quality of such a device. Similarly, quality products are vital in realms that are considered to be life-support applications. Underwater or upper atmosphere devices that provide life support require high-quality, high-reliability components. Aerospace applications often have critical components for which there is no backup or redundancy, and those components must be of the highest quality to minimize the possibility of losing a vehicle or a crew.

Ensuring the quality of products during development and production, during future update cycles, and for retroactive failure analysis is undoubtedly a desirable feature in any manufacturing cycle. New systems that ensure quality by testing must be developed in the future.

### SUMMARY

Testing must be accomplished in all realms of computer and electronic devices, whether during design, production, failure analysis, and so on. Design verification must be accomplished during the design phase to ensure that a device-under-test (DUT) accomplishes the design goals. In the production cycle, testing can ensure functionality and quality and can minimize the possibility of anomalous functionality after device deployment. Tests can include characterization and verification of bus performance. Testing can include performance corner testing, parametric testing, functional testing, and more. Testing can also include manufacturer and industry compliance testing. The aforementioned and similar high-speed bus interfaces are complex. They can comprise many signals such as data, control, clock, interrupt, power, and others. A bus controller can be included, which can include complex logic and state machines which also must be tested thoroughly. The number of use cases of high-speed buses and associated control logic is typically high. To ensure functionality, longevity, and quality, tests of all variants and anomalous conditions must be performed. This task is especially difficult when the testing of hardware does not allow easy access to internal signals to help with analysis and debugging. Disclosed embodiments can improve quality testing through the use of a trace-based encoder with software access points.

Sophisticated computer and electronic device testing techniques are disclosed. A test environment is accessed. The test environment includes a trace encoder and a software device-under-test interface (SDI). The SDI is coupled to a device-under-test (DUT). Software access points are inserted into the SDI to allow observability of one or more internal signals within the SDI. Modification instructions that cause the SDI to autonomously alter a response to the DUT are programmed into the SDI. The modification instructions are based on a test instruction set architecture. A test sequence is sent to the SDI, causing communications with the device under test. Replies are received from the DUT. The SDI responds to the replies and sends additional communications to the device under test. Additional replies are obtained from the DUT. A trace encoder creates a logic trace comprised of the states of the software access points.

A processor-implemented method for testing is disclosed comprising: accessing a testing environment, wherein the testing environment includes a target device domain, wherein the target device domain includes a trace encoder software device-under-test interface (SDI), and wherein the SDI is coupled to a device-under-test (DUT); inserting, into the SDI, a plurality of software access points, wherein the plurality of software access points allow observability, by the trace encoder, of one or more internal signals within the SDI; programming, by a user, the SDI with one or more modification instructions, wherein the one or more modification instructions cause the SDI to alter a response to the DUT, and wherein the one or more modification instructions are based on a test instruction set architecture (TISA); sending, by the user to the SDI, a test sequence, wherein the test sequence causes the SDI to send one or more communications to the DUT; receiving, by the SDI, one or more replies from the DUT, wherein the one or more replies are responsive to the test sequence; responding, by the SDI, to the one or more replies from the DUT, wherein the responding includes one or more additional communications to the DUT, and wherein the responding is based on the one or more modification instructions; obtaining, by the SDI, one or more additional replies from the DUT, wherein the one or more additional replies are responsive to the responding; and creating, by the trace encoder, a logic trace, wherein the logic trace includes one or more states of the plurality of software access points, and wherein the creating is based on the sending, the receiving, the responding, and the obtaining. Some embodiments comprise setting a state of the SDI, wherein the setting is accomplished by the plurality of software access points, and wherein the setting preconditions the SDI for the responding. In embodiments, the programming comprises converting, by a code exerciser within the target device domain, the one or more modification instructions into one or more packetized communications to the SDI. In embodiments, the test sequence comprises one or more opcodes from within the TISA.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for trace-based testing with software access.

FIG. 2 is a flow diagram for programming modification instructions.

FIG. 3 is a block diagram of a testing environment.

FIG. 4 is an example of a trace.

FIG. 5 is an example of a trace format.

FIG. 6 is an infographic for a flexible instruction set architecture.

FIG. 7 is an example opcode listing for a TISA.

FIG. 8 is a system diagram for trace-based testing with software access points.

### DETAILED DESCRIPTION

In electronic devices such as computers, networks, manufacturing control systems, and the like, data can be carried between source and destination by means of a bus. A bus can be comprised of one or more paths that carry data as well as control signals, synchronization clocks, and so on. Paths can be electrical conductors, fiber-optic conduits, etc. The effects of propagation delay and crosstalk in a transmission medium can result in timing skews among separate signals. Bus design has moved toward schemes that involve as few parallel paths as possible that need to remain in synchronization, yet can still operate at very high speeds. Improvements in bus capacity can be realized when high-speed, differential pair, serial transmission schemes replace lower-speed parallel bus topologies. Various high-speed industry standard buses can include PCI Express (Peripheral Component Interconnect Express or PCI-E), Compute Express Link (CXL), Universal Serial Bus (USB), Ethernet, and so on. Common across these and similar high-speed bus standards is the concept of packetized communication.

Computer and electronic devices require testing during multiple phases and milestones in the product life. Typical phases of a product life cycle include design, prototyping or pilot manufacturing, production, field failure analysis, and other phases. Verification can be a significant part of the design cycle to ensure that design goals are attained. Testing during and after production can ensure functionality, quality, and longevity of a product. Failures in the field can be returned for testing to determine root cause, appropriate fixes, and design modifications and upgrades. An area of computer and electronics devices that gets significant attention is characterization and verification of bus performance. Testing can include performance corner testing, parametric testing, functional testing, and more. Testing can also include manufacturer compliance testing and industry compliance testing. Testing methodologies can rely on developers to catalog the behavior of various aspects of an application, after which a testing protocol can be defined and developed to verify that behavior.

An application can be a distributed architecture, located in widely separated sites, employing one or more programming languages, one or more design teams, and the like. System traffic, as it progresses through a network, can traverse a complex and large set of hardware devices, operating systems, application programming interfaces (APIs), services, and the like. In distributed architectures it can be difficult to predict all of the possible use cases and application behavior. Further, when devices are committed to hardware, it can be challenging to determine internal states which cause observed errors. The disclosed techniques relate to trace-based testing. A significant component of system testing is observability. The concept of trace-based testing is to observe behavior that is granular to overall system behavior, and subsequently to leverage the understanding of data flow, system responses, and system performance when building system tests. Trace-based testing allows a developer to operate and observe at a transaction level to understand the relationship dependencies among components in a system.

High-speed bus topologies can be an example of a distributed system in which data traverses many hardware and software layers in a system. High-speed bus interface designs can be complex. They can include two or more logic interfaces communicating over a shared bus at high speeds. Further, these interfaces can include many signals such as data, control, clock, interrupt, power, and others. The number of use cases is typically high. To ensure functionality, longevity, and quality, tests of all variants and anomalous conditions must be performed and errors must be quickly understood, especially once a design is committed to hardware. Disclosed embodiments assist in debugging hardware errors by providing insight into a device-under-test (DUT) by instrumenting a software interface and capturing a trace under autonomous modification of test sequences by test opcode from a test instruction set architecture (TISA). Disclosed techniques can be accomplished by test systems in a number of ways. A DUT test system can include a benchtop apparatus that integrates the DUT with various stimulus tools, measurement tools, and computer or other control systems. A DUT test system can include a dedicated test system that can be designed and constructed for the particular DUT testing scenario at hand. A DUT test system can include automated test equipment (ATE) that can be programmed and controlled to accomplish the tests.

One high-speed bus industry standard that can be used in electronic communications is PCI Express (Peripheral Component Interconnect Express) or PCI-E. PCI-E is a common interface that is used for communication among electrical components, motherboards and daughtercards, and so on. A key measurement of PCI-E capability pertains to the number of lanes in use. A lane can be a pair of differential signals, where each differential signal consists of two conductors. One pair of differential signals can be used for transmitting to a distant device and the other pair for receiving from that device. Data traffic in a lane can operate at high speeds, sometimes in the gigabit-per-second range, for PCI-E bus devices. Data is transmitted and received in packetized form. Clock synchronization signals are embedded in the serial data, which obviates the need for a closely synchronized parallel clock signal. In embodiments, PCI-E can be implemented as a single lane (x1) architecture for lower-speed applications. PCI-E embodiments can achieve higher overall data transfer if they use additional lanes. The PCI-E standard is flexible and can allow device negotiation to determine lane count and overall bus speed. Embodiments of the PCI-E interface can accommodate from one to 32 lanes.

PCI-E interconnectivity can be managed by a PCI-E controller. A PCI-E root complex is a PCI-E controller device that can connect a central processing unit (CPU) and a memory subsystem to the PCI-E switch fabric that is comprised of one or more PCI-E endpoint devices and other similar endpoint devices. The PCI-E root complex can be connected to the CPU through a local and fast bus structure. The PCI-E root complex function can be included in a chipset form or, with trends in die-shrink and transistor density, can be incorporated directly within the CPU to reduce signal latency and increase speed. If the target device domain includes a PCI-E endpoint device, the test system can mimic a PCI-E root complex. If the target device domain includes testing a PCI-E root complex, the test system must mimic a PCI-E endpoint device.

Another bus standard that is similar to PCI-E is the Compute Express Link (CXL). CXL is an interconnect specification that is based on the PCI-E 5.0 physical and electrical layer infrastructure. The CXL standard includes new protocols, among which are cache-coherent protocols that facilitate the access to device memory and system memory. CXL was designed for a high-speed interconnect between a CPU and an endpoint device, a CPU-to-memory interconnect, and so on. Such interconnects can be found in high-performance data center computers, server farms, and other places. The Universal Serial Bus (USB) is also a serial bus standard. At the electrical level, early USB variants included a single differential pair of conductors that were used in half-duplex mode. Variants of USB have one dedicated differential pair of conductors for legacy purposes and include two or four pairs of conductors that operate in full-duplex mode for significantly higher transmission speed. The Ethernet networking technology is commonly found in local area networks (LANs), wide area networks (WANs), and other communications topologies. Modern versions of Ethernet use twisted-pair or fiber-optic conductors for serial data transmission. Ethernet speeds have increased from a few megabits-per-second to several hundred gigabits-per-second and higher.

These and similar interconnect standards employ the concept of packetized communications. In packet networking schemes, data can be grouped into packets that are transmitted to destinations. Packets can contain a header and a payload. Header information can include information regarding source address, destination address, packet ordering, and so on. The size of the header compared to the size of the payload can be a measure of overall traffic speed. As a packet travels through a network, network switch devices can receive and retransmit the packets through appropriate paths to route each packet to its final destination where the payload can be extracted by the operating system, application software, or other layers in the target device domain. Packet routing can include a fabric, mesh, crossbar switch, and so on, through which packets can travel. Multiple packets transmitted by a source to a destination can travel through different routes through the fabric depending on availability, packet ordering, and other parameters. Packet switching can be efficient in contrast to fixed or pre-allocated bandwidth schemes or other means of data transport, because once a packet is transmitted, the transmitting device can be made available to transfer other traffic. The disclosed techniques can include packetized communications for testing a DUT.

Disclosed embodiments provide a system wherein a software interface that communicates with a DUT via a packetized interface can be instrumented. Thus, critical signals in the software interface can be observed, monitored, captured, traced, and/or stored. The resulting trace of the instrumented signals can provide insight into inaccessible internal states of the DUT, improving the testing and debug process of the DUT. For example, a packetized user interaction with a DUT may result in four separate packetized communications. The first three communications may be error responses from the DUT, but the fourth may be a correct communication. The three errors may be based on a physical link layer. In this case, a user will not have insight into the nature of the error since the transaction will be marked as successful based on the fourth attempt. By using an instrumented software interface, the user can gain insight into link training and status state machine (LTSSM) states and transmitter/receiver order sets within the instrumented software interface. Thus, the first three errors will be easily observed with signal information representing internal states of the software interface. This trace information can be used to gain significant understanding into the DUT hardware, greatly assisting with testing and debugging.

In disclosed embodiments, a testing environment is accessed. The testing environment includes a target device domain. The target device domain includes a trace encoder and a software device-under-test interface (SDI). The SDI is coupled to a device-under-test (DUT). Multiple software access points are inserted into the SDI. These software access points allow the trace encoder to have observability into internal signals inside the SDI. The SDI is programmed by a user. The programming includes modification instructions. When received by the SDI, the modification instructions cause the SDI to alter a response that was to be sent to the DUT. The modification instructions are based on a test instruction set architecture (TISA). A test sequence is sent to the SDI by a user. The test sequence causes the SDI to send communications to the DUT. The SDI receives replies from the DUT. The replies from the DUT are responses to the test sequence. The SDI responds to the replies from the DUT. The response by the SDI includes additional communications to the DUT. The response by the SDI is based on the programmed modification instructions. The SDI obtains additional replies from the DUT. The additional replies are responsive to the additional communications to the DUT. The trace encoder creates a logic trace. The logic trace includes the states of the software access points that were inserted into the SDI. The creating is based on sending the test sequence, receiving replies from the DUT, responding by the SDI, and obtaining additional replies from the DUT.

In embodiments, a user accesses the logic trace which is stored in a trace memory. The user can then compare the logic trace to an expected logic trace. In other embodiments, the test sequence comprises opcodes from within the TISA. The opcodes can include opcodes for control and testing of the DUT. Additional embodiments include a fetch and decode unit that fetches and decodes the programmed modification instructions. In other embodiments, the logic trace includes a count, wherein the count records a number of times that a same packetized communication occurred between the SDI and the DUT.

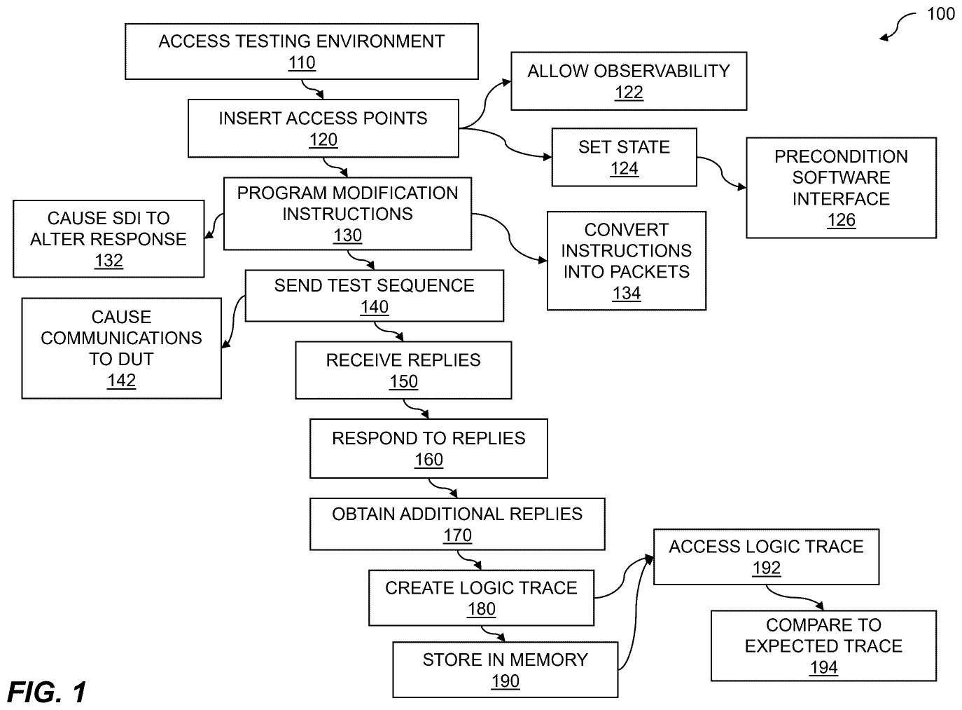

FIG. 1 is a flow diagram for trace-based testing with software access. Disclosures include a testing methodology that allows a user to define internal access points in the operation of, and communication with, a DUT. These access points can allow observability of signals within the SDI, which is the interface to the DUT. The user can also develop and insert modification instructions based on the TISA. The modification instructions can respond to replies from the DUT resulting from a test sequence sent to the DUT over a packetized interface such as PCI-E. The subsequent replies obtained from the DUT are interpreted by the trace encoder, and a logic trace can be created and stored. The logic trace gives significant insight into the workings and interactions between software and hardware layers in the interconnect interface to the DUT, which can assist with more precise system test, development, and debug, providing greater confidence in system performance, industry compliance, and the like.

The flow 100 includes accessing a testing environment 110, wherein the testing environment includes a target device domain, wherein the target device domain includes a trace encoder and a software device-under-test interface (SDI), and wherein the SDI is coupled to a device-under-test (DUT). Embodiments include a trace encoder that can decode communication packets received from the DUT. Other embodiments include the SDI as a software-to-hardware interface component. Interface circuitry includes hardware driver electronics structures and receiver electronics structures that are designed to match the electrical conditions and similar parameters of the DUT, and enables reliable electrical communication to and from the DUT. In embodiments, the SDI is coupled to the DUT. The DUT can be a hardware device. The DUT can be local to the testing environment in the target device domain, or it can be at a distant location. Multiple configurations between the SDI and DUT are possible.

In embodiments, the SDI includes a PCI-Express (PCI-E) controller. In other embodiments, when the SDI includes a PCI-Express (PCI-E) controller, the PCI-express controller comprises a PCI-E root complex. In this case, in further embodiments, the DUT comprises a PCI-E endpoint device. In other embodiments, when the SDI includes a PCI-Express (PCI-E) controller, the PCI-express (PCI-E) controller comprises a PCI-E endpoint device. In this case, in further embodiments, the DUT comprises a PCI-E root complex.

In other embodiments, the SDI includes a CXL controller. In further embodiments, the DUT comprises a CXL controller. In other embodiments, the SDI includes an ethernet controller. In this case, the DUT can comprise an ethernet controller. In other embodiments, the SDI includes a USB controller. In this case, the DUT can comprise a USB controller.

The flow 100 includes inserting, into the SDI, a plurality of software access points 120, wherein the plurality of software access points allows observability, by the trace encoder, of one or more internal signals within the SDI. The insertion of access points can be accomplished through means of interactive commands entered at a user's workstation, through the exercising of a previously stored file containing access points, or by other means. In embodiments, the software access points can allow observability 122 of one or more internal signals within the SDI by means of the trace encoder. The software access points can allow the user to set a state 124 of the SDI. The software access points can allow the user to observe the internal signals. Embodiments include setting a state 124 of the SDI, wherein the setting is accomplished by the plurality of software access points, and wherein the setting preconditions 126 the SDI for the responding.

The flow 100 includes programming, by a user, the SDI with one or more modification instructions 130, wherein the one or more modification instructions cause the SDI to alter a response to the DUT, and wherein the one or more modification instructions are based on a test instruction set architecture (TISA). The TISA can be designed for the testing of complex high-speed and similar interfaces. The TISA can include opcodes that enable test sequences, read back responses, compare results, and so on. In embodiments, the one or more modification instructions cause the SDI to alter a response to the DUT 132. For example, using the PCI-E protocol, a DUT can send a data packet to the SDI. In response, the SDI can send an ACK message to the DUT to acknowledge that the data packet was received. The modification instructions can instruct the SDI to instead send a NACK (negative acknowledgment) which will tell the DUT that the data packet was not received. In this way, the modification instructions can test the DUT's reaction to unexpected error conditions. In embodiments, the programming comprises converting, by a code exerciser within the target device domain, the one or more modification instructions into one or more packetized communications 134 to the SDI. The DUT communication path can be optimized for packetized communication which can be used for communication between electronic devices at gigabit speeds.

The flow 100 includes sending, by the user to the SDI, a test sequence 140, wherein the test sequence causes the SDI to send one or more communications to the DUT. The sending can be accomplished by interactive test commands entered at the user's workstation, by exercising a previously stored file containing a test sequence, and so on. The test sequence can consist of opcodes, commands, data, and the like that are intended to set up and stimulate the DUT to perform in an expected manner or reveal unexpected behavior within the DUT. In embodiments, the test sequence comprises a compliance test. In embodiments, the test sequence causes the SDI to send one or more communications to the DUT 142. Packetized communications can be sent through an electronic interface circuitry within the SDI. The interface circuitry can include hardware driver and receiver circuitry that is designed to match the electrical conditions and parameters of the DUT, thus enabling reliable electrical communication to and from the DUT. In embodiments, the test sequence consists of one or more opcodes from within the TISA. In embodiments, the TISA includes one or more opcodes for control and testing of the DUT.

The flow 100 includes receiving, by the SDI, one or more replies from the DUT 150, wherein the one or more replies are responsive to the test sequence. Recall that the DUT was previously sent a test sequence by means of packetized communications to functionally exercise its circuitry and logical processes. The one or more replies can reveal the response to the packetized communications. Some received responses can be expected responses based on the stimulus of the packetized communications that were sent to the DUT. Other received responses can be unexpected and can reveal behavior that needs to undergo scrutiny and may prompt possible design changes. The one or more replies can be included in a packetized communication to the SDI. The flow 100 includes responding, by the SDI, to the one or more replies from the DUT 160, wherein the responding includes one or more additional communications to the DUT, and wherein the responding is based on the one or more modification instructions. In embodiments, the responding includes one or more additional communications, sent autonomously to the DUT, that are triggered by the modification instructions. As explained previously, the modification instructions can cause the SDI to alter a response to the DUT. Replies to the communications that were based on the modification instructions received from the DUT can reveal expected or unexpected functionality of the DUT. The modification instructions, previously programmed, can more completely exercise DUT functionality.

The flow 100 includes obtaining, by the SDI, one or more additional replies from the DUT 170, wherein the one or more additional replies are based on the responding. The DUT can return additional replies from the stimulus of the aforementioned modification instructions. The SDI and DUT can communicate many times back and forth. During these communications, the modification instructions can continue to change the SDI's responses to the DUT to test other aspects of the DUT functionality. Additional modification instructions can be added to the SDI at any time before, during, or after testing of the DUT, through the programming interface. Likewise, existing modification instructions can be removed at any time before, during, or after testing of the DUT. In embodiments, the one or more communications and the one or more additional communications are packetized.

The flow 100 includes creating, by the trace encoder, a logic trace 180, wherein the logic trace includes one or more states of the plurality of software access points, and wherein the creating is based on the sending 140, the receiving 150, the responding 160, and the obtaining 170. The trace encoder can convert the packetized communications from the DUT into a computer readable format that can be used for further understanding of the performance of the DUT. In embodiments, the logic trace includes one or more inputs to the SDI. In embodiments, the logic trace includes one or more outputs from the SDI. In embodiments, the logic trace comprises one or more 64-bit words. The logic trace can contain many such 64-bit words, representing any number of communications back and forth between the SDI and the DUT. In other embodiments, the logic trace comprises 128-bit words. The logic trace can contain many such 128-bit words, representing any number of communications back and forth between the SDI and the DUT. The trace can contain one or more timestamps. In embodiments, each line of the trace includes a separate timestamp. The timestamp can include fields for minute, second, millisecond, microsecond, nanosecond, and so on. The timestamp can represent real system time between events in the trace since the SDI was reset. To save storage space, in embodiments, the logic trace includes a count, wherein the count records a number of times a same packetized communication occurs between the SDI and the DUT. The logic trace can include critical signals in the SDI that can be observed, monitored, captured, traced, and/or stored. The resulting trace of the instrumented signals can provide insight into inaccessible internal states of the DUT, improving the testing and debug process of the DUT. For example, a packetized user interaction with a DUT may result in four separate packetized communications. The first three communications may be error responses from the DUT, but the fourth may be a correct communication. The three errors may be based on a physical link layer. Thus, in this case, a user will not normally have insight into the nature of the error since the transaction will be marked as successful based on the fourth attempt. By inserting and monitoring access points in the SDI, the user can gain insight into link training and status state machine (LTSSM) states and transmitter/receiver order sets as they occur in the SDI. Thus, the first three errors will be easily observed as the logic trace is created with signal information representing internal states of the access points. This trace information can be used to gain significant understanding into the DUT hardware, greatly assisting with testing and debugging.

The flow 100 includes storing 190 the trace memory. Embodiments include accessing 192, by the user, the logic trace, wherein the logic trace is stored in a trace memory. The logic trace can then be interactively analyzed by the user at a workstation; saved for subsequent analysis; saved for analysis after an appropriate group of tests have been performed; used as historical documentation within the development, manufacturing, or industry compliance realms; and so on. Since the SDI can be instrumented, critical signals in the communications between the SDI and the DUT can be monitored, captured, traced, and stored. The trace can offer significant insight into internal states of the hardware DUT without having test access to internal signals. In embodiments, the accessing further comprises comparing the logic trace to an expected logic trace 194. Comparison of actual trace data with expected trace data can reveal expected or anomalous functionality of the DUT. The comparison can be used to direct modifications to the DUT during development; direct modifications to the software access points; update test sequences; change modification instructions to produce more observability in the DUT through the SDI; and so on.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

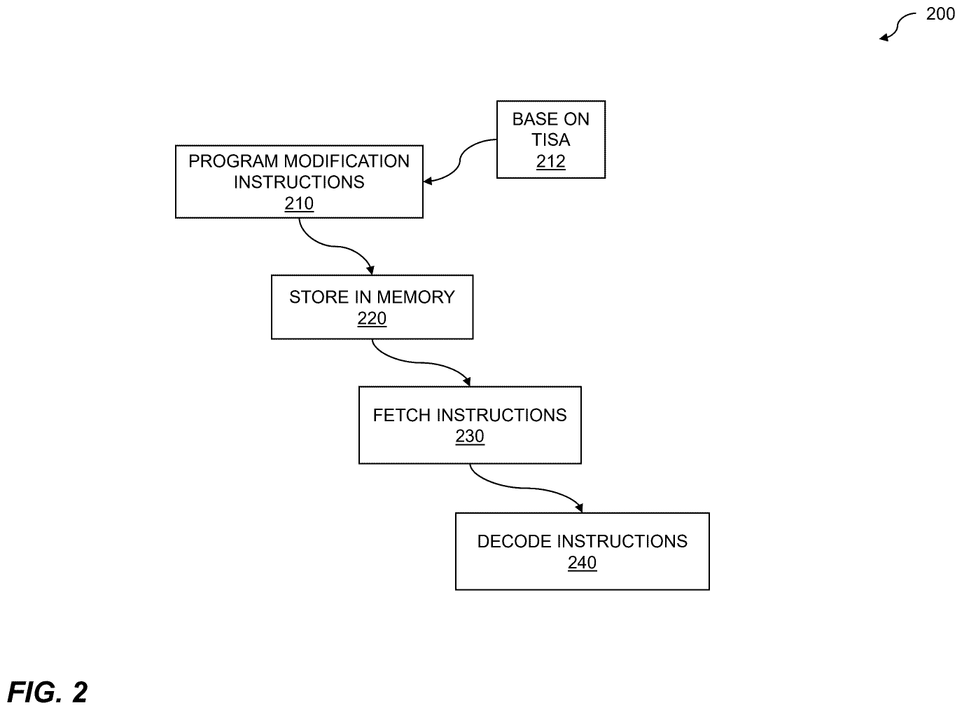

FIG. 2 is a flow diagram for programming modification instructions. As described above and throughout, modification instructions can cause the SDI to alter a response to the DUT. The target device domain can include sending and receiving communication packets between the SDI and the DUT. This can include testing the DUT by exercising specific functions and protocols by the SDI. However, the SDI can further test the DUT by sending an unexpected communication to the DUT. For example, the SDI can assert an error when the DUT has returned data not associated with an error. In this way, additional testing can be performed on the DUT.

The flow 200 includes programming, by a user, the SDI with one or more modification instructions 210, wherein the one or more modification instructions cause the SDI to alter a response to the DUT, and wherein the one or more modification instructions are based on a test instruction set architecture (TISA) 212. As described previously, the TISA can be designed for the testing of complex high-speed, and similar interfaces. The TISA can include opcodes that enable test sequences, read back responses, compare results, and so on. In embodiments, the one or more modification instructions cause the SDI to alter a response to the DUT. For example, using the PCI-E protocol, a DUT can send a data packet to the SDI. In response, the SDI can send an ACK message to the DUT to acknowledge that the data packet was received. The modification instructions can instruct the SDI to instead send a NACK (negative acknowledgment) which will tell the DUT that the data packet was not received. In this way, the modification instructions can test the DUT's reaction to unexpected error conditions. In embodiments, the programming comprises converting, by a code exerciser within the target device domain, the one or more modification instructions into one or more packetized communications to the SDI. The DUT communication path can be optimized for packetized communication which can be used for communication between electronic devices at gigabit speeds.

The TISA can include one or more opcodes for control and testing of the DUT. The TISA architecture can be designed with arguments, feature codes, and source ID codes to functionally exercise elements of the DUT. In embodiments, the TISA comprises one or more data words. In embodiments, a first data word within the one or more data words comprises 32 bits, divided into multiple bit fields. A first bit field can include an opcode field. The opcode field can comprise five bits. Additional bits can be allocated to the opcode field to provide up to 2\hat{ }N opcodes, where N is the total number of bits in the opcode field. The TISA can include a first argument field. The TISA can include a second argument field, a third argument field, and so on. The TISA can be a flexible test instruction set architecture that can be optimized for the communications protocol being used.

The flow 200 includes storing, in an instruction memory, the one or more modification instructions 220. Storage platforms can include storage internal to the user's computer system, storage internal to the computer in the target device domain, storage internal to the electronic controller with the target device domain, and so on. Storage platforms can include various types of memory. Memory types can include static random-access memory (SRAM), dynamic random-access memory (DRAM), embedded DRAM (eDRAM), and similar volatile memory types that maintain their state while power is applied. Other memory types can maintain their stored information after power is removed. These memory types can include NAND flash and NOR flash memory that can be electrically erased and rewritten, USB flash drives, and so on. Storing can include compression to save space. Various compression methods can be employed. Compression methods can search for and remove redundancies in the data. Depending on the type of data being compressed, significant reductions in data set size can be realized. Reduction in data set size can result in reductions in memory storage space and in data transmission time.

The flow 200 includes fetching 230, by a fetch and decode unit, the one or more modification instructions, wherein the fetching includes decoding the one or more modification instructions. The function of the fetch can be to retrieve the next instruction that is stored in memory. The fetch can be followed by the execution of the code exerciser, explained below. The fetched modification instruction can include additional operands or arguments, addresses, configurations, and so on that may need decoding instructions 240. After instruction decode, the modification instructions can be converted by software, or hardware, or a combination of software and hardware into packetized instructions that are recognizable to the SDI and the DUT. Some modification instructions can result in a single communications packet that is sent to the DUT. Other modification instructions can cause multiple communications packets to be sent to the DUT.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

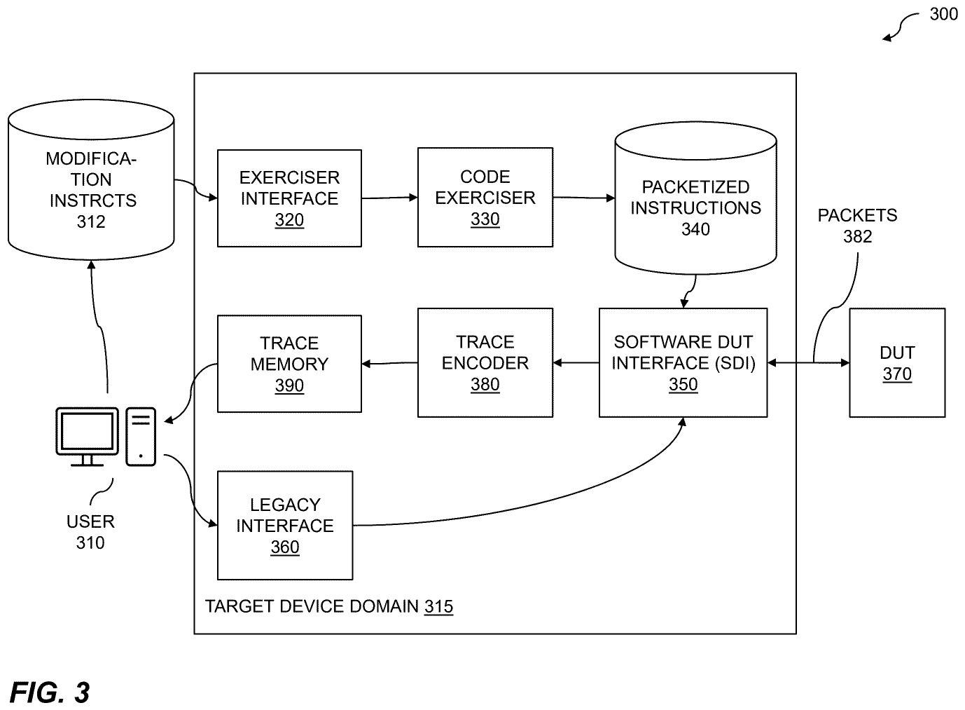

FIG. 3 is a block diagram of a testing environment. The block diagram 300 illustrates the relationship of the user to the target device domain, and the relationship of the target device domain to the DUT. The user can interact with the target device domain by accessing and interacting with the domain by an operator's console and an associated compute device. The compute device can be a computer, workstation, mobile device, and so on. The user can also utilize previously stored test commands, sequences, files, and the like to initiate actions in the target device domain. Embodiments include programming, by the user, the SDI with one or more modification instructions. Modification instructions can be stored in a storage device during test generation. The target device domain can contain hardware that emulates various packetized communications interconnect protocols such as PCI-E, CXL, USB, Ethernet, and others. In embodiments, the one or more modification instructions are based on a test instruction set architecture (TISA). The disclosed TISA and its interaction within the target device domain are illustrated. It will be seen that the TISA can have a significant role in test coverage of a DUT.

The block diagram 300 can include a user 310 that can interact with a target device domain 315. The interactions can include inserting information, programing, sending instructions, reading data, and so on. The user can interact with the target device domain at various phases before, during, and after a test process. The user can interact with the target device domain by use of human interface devices (HID) that are connected to a computer. The computer can host software for test generation, test analysis, and more. The computer can be a standalone computer such as a computer on the user's desktop, a computer that is embedded in electronic circuit boards within the target device domain, and other types of computers or controllers. The computer can be a workstation. In embodiments, the computer is a mobile device. The computer can allow interactive test generation by means of test software, programming environment software, and so on. The computer can allow results analysis to be performed during test sequences, subsequent to test completion, and so on. The block diagram 300 includes programming, by a user, the SDI with one or more modification instructions 312, wherein the one or more modification instructions cause the SDI to alter a response to the DUT, and wherein the one or more modification instructions are based on a test instruction set architecture (TISA). These instructions can be programmed in human-readable form and can be stored within the computer that runs the test creation software, within a resident computer in the target device domain, and so on. Modification instructions 312 can be programmed to functionally exercise hardware, data streams, interconnect negotiations, link requests, and more. Link requests can include configuration, input/output (I/O), memory read/write, and so on. Modification instructions 312 can be used to test how the DUT responds when an instruction is modified to return an unexpected event to the DUT. Modification instructions can be converted to machine-readable form, and ultimately to packetized communications.

The block diagram 300 can include a target device domain 315. The target device domain can include one or more software interfaces for interaction with the user. The interfaces can include an exerciser interface, a legacy interface, and a trace memory interface. The interfaces can include software that runs directly on a computer system in the target test environment. This can also include software that resides and runs on a separate computer that can be connected via dedicated cabling schemes, a local area network, a wide area network, a virtual private network, and so on. The target device domain can also include functionality for supporting the test interfaces such as a code exerciser 330 and a trace encoder 380. The target device domain can further include the SDI 350 comprising a software-to-hardware interface to the DUT. The target device domain can also include other input, output, miscellaneous signals, and the like that can be used during the creation of test sequences, software access points, and modification instructions, and can be further used during testing, debugging, analyzing test results, and more. The target test domain can include components that comprise a flexible test instruction set architecture to provide an instruction set that can be optimized for the DUT.

The block diagram 300 can include an exerciser interface 320. The exerciser interface 320 can receive the modification instructions 312 from a storage location. As previously noted, modification instructions 312 can be converted, by the code exerciser 330, into packetized instructions 340 that are used to alter communications between the SDI 350 and the DUT 370. The exerciser interface 320 can provide the software interface layer and protocol interface between modification instruction storage and the modification instruction decoding. The exerciser interface can include one or more types of random-access memory (RAM), in which modification instructions are stored and made ready for processing. RAM can include dynamic random-access memory (DRAM) which can further include technology variants that provide suitable speed and density. RAM can include static random-access memory. The exerciser interface can include a fetch and decode unit. Embodiments include fetching, by a fetch and decode unit, the one or more modification instructions 312. The exerciser interface 320 can fetch instructions from RAM based on an instruction pointer, program counter, and so on. The fetching can include decoding the one or more modification instructions. The decoding can include the analysis and interpretation of the instruction, peripheral data fields that modify and direct the instruction, sets configuration states, and so on.

The block diagram 300 can include a code exerciser 330. The code exerciser 330 can translate modification instructions captured by the exerciser interface 320 into packetized instructions 340 to be sent to the SDI. Thus, embodiments include converting, by a code exerciser within the target device domain, the one or more modification instructions into one or more packetized communications to the SDI. The code exerciser can convert the user's programmed modification instructions into a packetized form that is compatible with the interconnect protocol used by the SDI. The code conversion can be accomplished by hardware circuitry, software program, firmware microcode, and so on. One modification instruction can result in one or more packetized instructions that will be sent to the SDI. The packetized instructions 340 can be sequenced and stored in a suitable memory structure for later inclusion of the modification instructions into the test sequence, sent by the user to the SDI. The SDI can incorporate the modification instructions at specific instances in the test sequence that is sent to the DUT 370. Recall that the SDI and DUT can communicate in PCI-E, CXL, USB, Ethernet, or other types of packetized communication protocols. The exerciser interface 320, code exerciser 330, and resulting packetized instructions 340 implement instructions that are included in the disclosed TISA. The TISA can be modified to suit the requirements of a particular DUT.

The block diagram 300 can include a software device under test interface (SDI) 350. The SDI can be a combination of software and hardware that can comprise a software-controlled, highly accessible hardware interface that logically and electrically comprises half of the pair of communicating devices; the DUT 370 can be the complementary half of the communicating devices. The SDI can be designed to make it easy to access and set configurations that are internal to the interconnect protocol and hardware. The SDI 350 can be further designed to send data that is optimized for the DUT communications protocol, receive responses from the DUT 370, understand the internal behavior of the DUT 370, and more. The SDI 350 is central to several functions within the target device domain. The SDI 350 can be the communications interface with the DUT 370 where software-to-hardware interface circuitry can include control circuitry, power supply circuitry, and more. Software-to-hardware interface circuitry can further include hardware driver electronics circuitry and receiver electronics circuitry that are designed to match the electrical conditions and similar parameters of the DUT 370 and enable reliable electrical communication to and from the DUT 370. The SDI 350 can receive and process the test sequence that initiates the interaction with the DUT 370. In embodiments, the test sequence causes the SDI 350 to send one or more communications to the DUT 370. Embodiments include receiving, by the SDI 350, one or more replies from the DUT 370. In other embodiments, the one or more replies are responsive to the test sequence. Packetized interfaces, such as PCI-E, CXL, USB, Ethernet, and so on, can carry responses that can include status of the communications. The SDI 350 can include, in the test sequence, the packetized modification instructions that interact with the DUT 370 to further test DUT 370 functionality. For example, with data transaction using the PCI-E protocol, the DUT 370 can send a data packet to the SDI 350. In a normal response, the SDI 350 can send an ACK message to the DUT 370 to acknowledge that the data packet was properly received. However, the modification instructions can instruct the SDI 350 to instead return a NACK (negative acknowledgment) to the DUT 370 which will tell the DUT that the data packet was not received. In this way, the modification instructions can test the DUT's reaction to unexpected functionality.

The block diagram 300 includes a legacy interface 360 that can include data and control paths for sending a test sequence to the SDI 350. Embodiments include sending, by the user, to the SDI 350, a test sequence, wherein the test sequence causes the SDI 350 to send one or more communications to the DUT 370. Recall that the SDI 350 can be configured by the insertion of a plurality of software access points to allow observability of one or more internal signals within the SDI 350. The legacy interface can also be used for general control of the target device domain; for starting and stopping the test process; for modifying tests and test sequences; for viewing and storing intermediate test results for later analysis; and so on. The legacy interface can include standard prototype or production test interface software, custom test interface software, and more.

The block diagram 300 can include the DUT 370. The DUT 370 hardware interconnect protocol can be one of a variety of packetized interconnect protocols 382, such as PCI-E, CXL, USB, Ethernet, or others. Elements associated with the DUT 370 can include a physical connection to the device; electrical signals sent and received from the device; logical data sent and received from the device; power supply required by the device; the test sequence and modification instructions of the TISA; and so on. The physical and mechanical connection to the DUT 370 can include a cable, test socket, test computer, and so on. The DUT can be local to the testing environment or can be in a remote location. The DUT physical and mechanical connection can include power and other peripheral signals that are required for functionality. Due to typical high speed interconnect protocols that often are at gigabits-per-second speeds, the electrical signals sent by the SDI 350 to the DUT 370 can be carefully matched in voltage levels, line impedances, and other parameters to ensure reliable transmission to the DUT. Likewise, the electrical signals received by the SDI 350 from the DUT 370 can be difficult to discriminate and appropriate receiver circuitry can be designed for reliable reception. The DUT 370 communication can be packetized and can necessitate a logical interface in the SDI 350 that can include negotiation, data handling, handshakes, and so on. The DUT 370 can receive one or more packetized communications that can result from the sending of the test sequence, as well as additional communications that incorporate modification instructions from the TISA.

The block diagram 300 can include a trace encoder 380. Embodiments include creating, by the trace encoder 380, a logic trace, wherein the logic trace includes one or more states of the plurality of software access points, and wherein the creating is based on the sending, the receiving, the responding, and the obtaining. Recall that a plurality of software access points could be inserted into the SDI 350. In embodiments, the plurality of software access points allows observability, by the trace encoder, of one or more internal signals within the SDI 350. The trace encoder 380 can access the SDI 350 to determine the states of the software access points, correlate the states with functional and logical blocks within the SDI 350 hardware, record states in a trace file, and so on. The trace can reveal data flow, status, expected behavior, anomalous behavior, etc. at a granular level internal to the interface to the DUT 370.

The block diagram 300 can include a trace memory 390. The trace memory can store the logic trace created by the trace encoder 380. The memory can include volatile random access memory (RAM), non-volatile flash or similar memory, spinning disk memory, and so on. Such memory resides within the target device domain. Embodiments further include accessing, by the user 310, the logic trace. Access can include viewing, at the user's workstation, the raw data containing software access points, viewing with the help of test software that can be designed for the interpretation of access points, viewing trace data remotely on a network, and so on. Embodiments include comparing the logic trace to an expected logic trace. Comparison can be performed for validation, verification, and more. Validation can help determine if the DUT 370 design will meet the acceptance and suitability needs of the customer. Verification can help determine if the DUT complies with manufacturer standards, production standards, industry standards, and others.

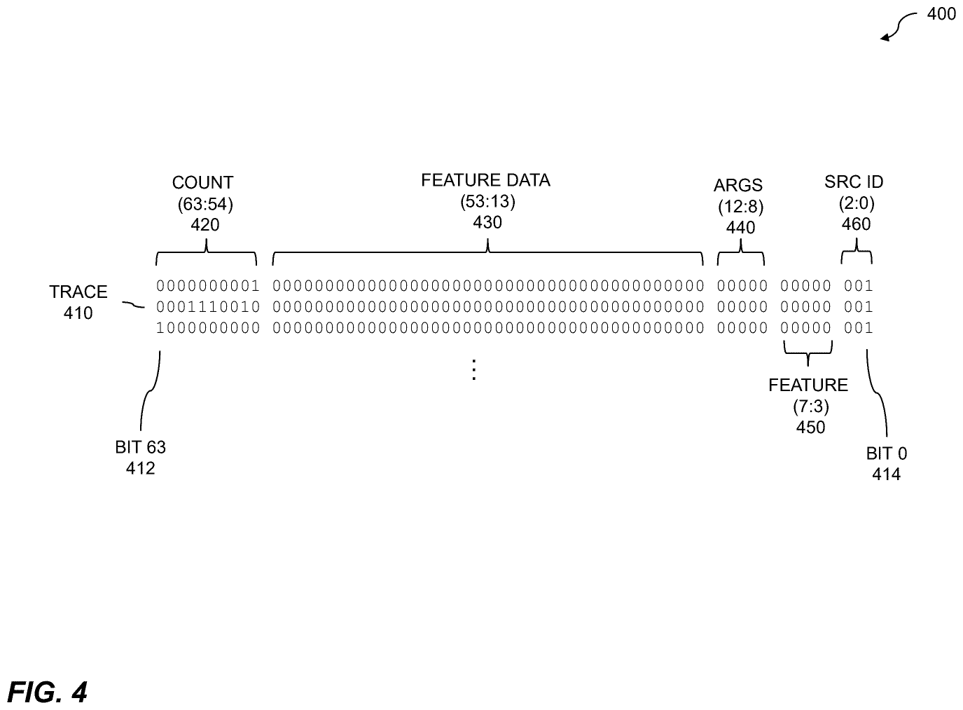

FIG. 4 is an example of a trace. A trace can be a human-readable or machine-readable listing that is created by the trace encoder from observation of pre-identified software access points within the SDI. In embodiments, the plurality of software access points allow observability, by the trace encoder, of one or more internal signals within the SDI. Thus, the logic trace can include the one or more internal signals within the SDI. In embodiments, the logic trace includes one or more inputs to the SDI. In other embodiments, the logic trace includes one or more outputs of the SDI. The trace can include the software states of the access points after a full cycle of sending, receiving, responding, and obtaining in the disclosed techniques. Since the SDI can be instrumented, critical signals in the communications between the SDI and the DUT can be monitored, captured, and traced. The captured trace can give significant insight into internal states of the DUT without having test access to internal signals. The trace can be stored in a memory that is embedded in the controller in the test environment, in a computer that is logically adjacent to the test environment, or in another location. The trace is accessible to the user in one or more forms depending on the analysis or other software that is used for access and interpretation. Embodiments include comparing the logic trace to an expected logic trace. The comparison, as previously mentioned, can be performed for the purpose of validation, verification, compliance, and more.

The example 400 includes a trace 410. In embodiments, the logic trace comprises one or more 64-bit words. The 64-bit trace word format can be composed of assigned fields, where bit 63 is the most significant bit 412 and bit 0 is the least significant bit 414. Each 64-bit word can be created based on test sequences sent from the SDI to the DUT, or responses from the DUT to the SDI. In embodiments, the trace can include the states of software access points that are associated with inputs to the SDI or outputs from the SDI. It is possible that the same 64-bit word is repeated many times during interactions between the SDI and the DUT. In this case, the trace could grow extremely large. To combat this, in embodiments, the logic trace includes a count 420, wherein the count records a number of times a same packetized communication occurred between the SDI and the DUT. The trace format can contain a 10-bit field that is associated with the count 420. At the highest-order position within the trace word, the ten-bit count field occupies bit 63 through bit 54. The count field, as illustrated, can allow 2\hat{ }10 occurrences of the same trace words to be documented. Additional bits can be allocated to the count field to provide up to 2\hat{ }N opcodes, where N is the total number of bits in the count field. The count field can save significant trace memory space and processing time in the DUT test process.

The example 400 can include additional data fields, including a feature data field 430. The feature data field width can be 41 bits, occupying bit 53 through bit 13. The feature data field can be variable by communication type and can be defined by a 5-bit feature field, described below. In embodiments, if the feature field contains a feature code that indicates an error, the feature data field can contain the command that was sent to the DUT for which an error occurred, and the 5-bit arguments field can contain the status or reason code for the error. In embodiments, arguments include a missed packet state, a command overwritten state, a command pending state, and so on. In other embodiments, if the feature field contains a feature code that points to a link training and status state machine (LTSSM) state, the feature field and argument field can contain the state that was received from the DUT for which an error occurred. In this case, the feature data field can be meaningless, and the 5-bit arguments field can include codes that identify a detect quiet state; detect active state; polling active state; polling compliance state; and so on. Additional bits can be allocated to the feature data field to provide up to 2\hat{ }N opcodes, where N is the total number of bits in the feature data field. The flow 400 includes a 5-bit argument field 440 that can contain the previously described argument codes that are associated with the previously described feature codes. The arguments field 440 can occupy bit 12 through bit 8. Additional bits can be allocated to the argument field to provide up to 2\hat{ }N possible argument codes, where N is the total number of bits in the argument data field. The 5-bit feature field 450 can occupy bit 7 through bit 3. Additional bits can be allocated to the feature field to provide up to 2\hat{ }N possible argument codes, where N is the total number of bits in the feature data field. The 3-bit source ID field 460 can occupy bit 2 through bit 0. The utility of these fields will become evident in a later figure. Field lengths can be modified for a particular test purpose and DUT.

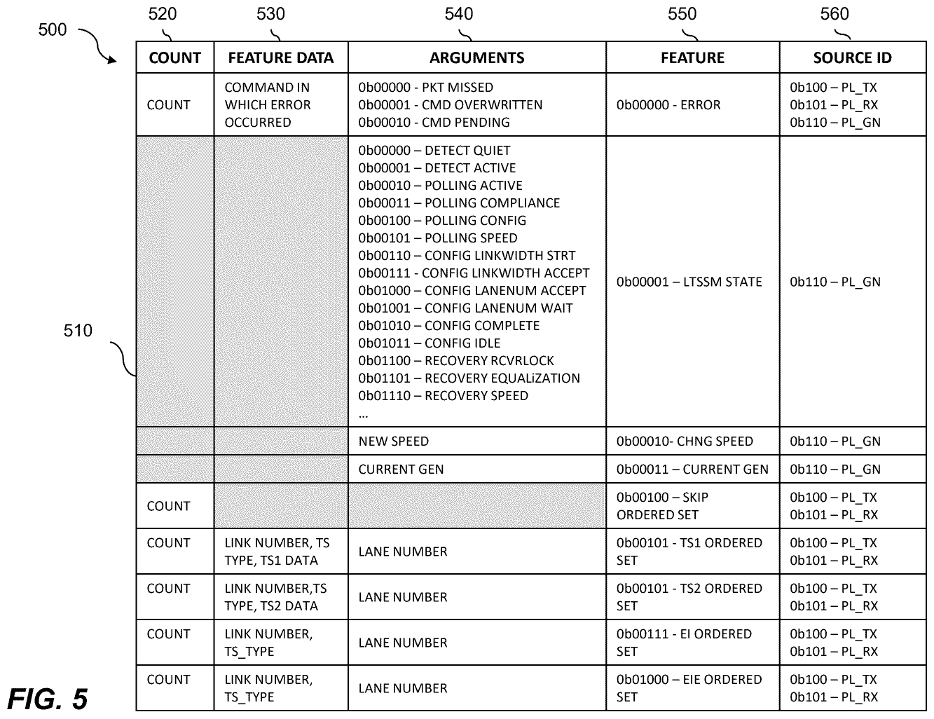

FIG. 5 is an example of a trace format. The trace format defines the meaning of data that can be listed in the logic trace. The logic trace can be a series of received entries from the DUT to the SDI, interpreted by the trace encoder and stored in the trace memory for access by the user. The various fields in the trace format have meaning depending on the feature that is used, as identified in a feature field.

The example 500 includes a table 510 of trace fields and codes that are possible in the testing of a variety of DUTs. Additional trace entries can be encountered depending on the TISA design, packetized DUT communications protocol, and so on. Expansion or modification of the trace format can accommodate additional device formats beyond PCI-E, CXL, USB, Ethernet, and other packetized interconnect solutions. The flow 500 can include a count field 520. As described above, the count field can reveal, in a single trace word, multiple instances of identical 64-bit word interactions between the SDI and DUT. The count associated with a trace word can significantly reduce trace storage space and trace encoding processing time, and later trace analysis time can be saved.

The example 500 can include a feature data 530 field, an arguments 540 field, and a feature 550 field. The meaning of the feature data 530 field is variable and can be defined by the feature field. In embodiments, if the 5-bit feature field contains a feature code that indicates an error, the feature data field can contain the command that was sent to the DUT for which an error occurred, and the 5-bit arguments field can contain the status or reason for the error. In embodiments, arguments can include a missed packet state, a command overwritten state, a command pending state, and so on. In the disclosed example, a missed packet state can be identified by the presence of the code 0b00000 in the arguments 540 field, an overwritten command would be identified by the presence of the code 0b00001, a pending command would be identified by the presence of the code 0b00010, and so on. In embodiments, if the 5-bit feature field contains a feature code that points to a link training and status state machine (LTSSM) state, the feature field and arguments field can contain the state that was received from the DUT for which an error occurred. In this case, the feature data 530 field can be meaningless. In embodiments, arguments can include a detect quiet state, detect active state, polling active state, polling compliance state, and so on. In the disclosed example, a detect quiet state would be identified by the presence of the code 0b00000 in the arguments 540 field, a detect active state would be identified by the presence of the code 0b00001, a polling active state would be identified by the presence of the code 0b00010, and so on.

The arguments 540 field can include packet-related codes, command state codes, link training status codes, information about link speed, ordered sets that are used for line calibration during link training, and so on. The feature 550 field can provide returned information such as an error command, link numbers, TS type, TS1 data, and other parameters associated with linking and testing of various types of communications protocols. The source ID 560 field can provide information regarding the transmission source, receiver destination, and so on. Recall that the logic trace can include one or more inputs or one or more outputs from the SDI. Trace format field widths and assignments can be modified as necessary for the interconnect protocol and device being tested.

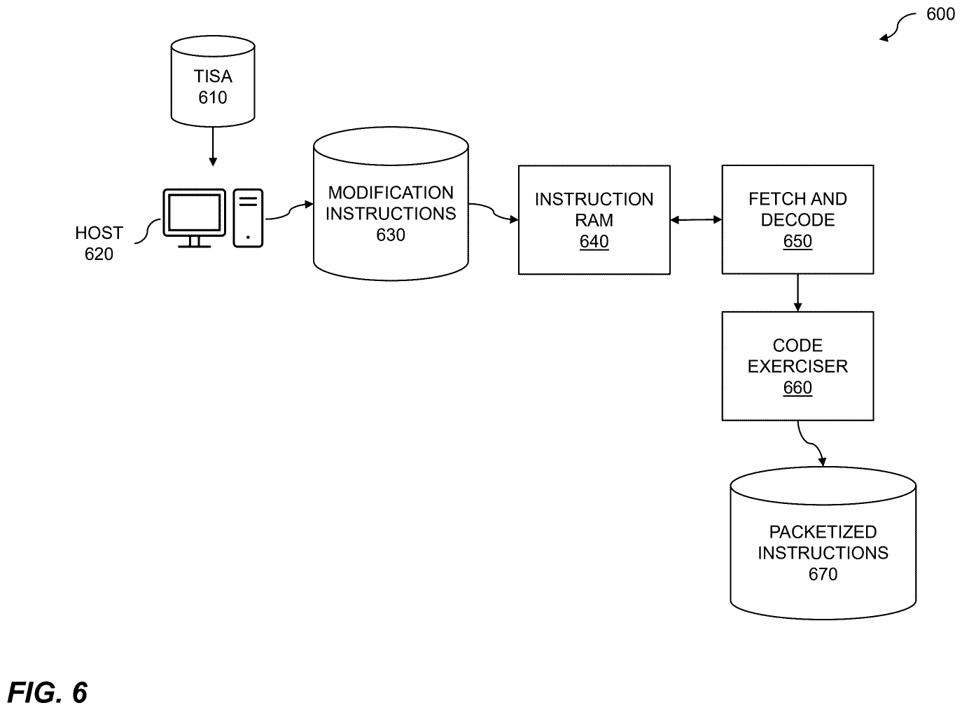

FIG. 6 is an infographic for a flexible instruction set architecture. The example architecture 600 includes a test instruction set architecture (TISA) 610. The TISA can include a plurality of opcodes. The opcodes can include opcodes for configuring and/or initializing a test environment, as well as opcodes for performing tests on a device-under-test (DUT). The TISA 610 can be loaded on, or be made accessible to, a host 620. The host 620 can include a computer, such as a desktop or laptop computer. The host 620 can include one or more applications executing thereon, such as compilers, linkers, assemblers, and/or other programs for the purposes of assembling a sequence of opcodes from the TISA 610 into modification instructions 630. The modification instructions 630 can then be loaded into instruction random-access memory (RAM) 640. The instruction RAM 640 can include dynamic random-access memory (DRAM). In one or more embodiments, the instruction RAM 640 is comprised of HBM (High Bandwidth Memory), DDR4 (Double Data Rate 4) RAM, DDR5 (Double Data Rate 5) RAM, or another suitable DRAM type. In some embodiments, the instruction RAM 640 can include static RAM (SRAM).

A fetch and decode (FAD) block 650 provides modification instructions from the instruction RAM 640 to the code exerciser 660. The FAD block 650 performs functions to enable generation of packetized instructions 670. The FAD block 650 can include a fetch stage. The fetch stage is the first step in the instruction execution cycle. The primary function of the fetch is to retrieve the next instruction from memory. The FAD may utilize input based on a program counter (PC) or instruction pointer to determine the memory address of the next instruction to be fetched. In embodiments, the fetch operation involves reading the instruction from the specified memory location in the instruction RAM 640 and loading it into an instruction register within the code exerciser 660 in preparation for execution of the instruction. The FAD block 650 may also include a decode stage. The decode stage can include examination of additional operands and/or arguments, address identification, and so on. The code exerciser can include a combination of hardware, software, and/or microcode for translating instructions into packetized communications. In embodiments, some opcodes within the TISA cause the code exerciser to create a single targeted packetized communication to the DUT. In other embodiments, some opcodes within the TISA cause the code exerciser to create multiple packetized communications, creating a hierarchical, flexible testing environment. Additional opcodes can be added to the TISA.

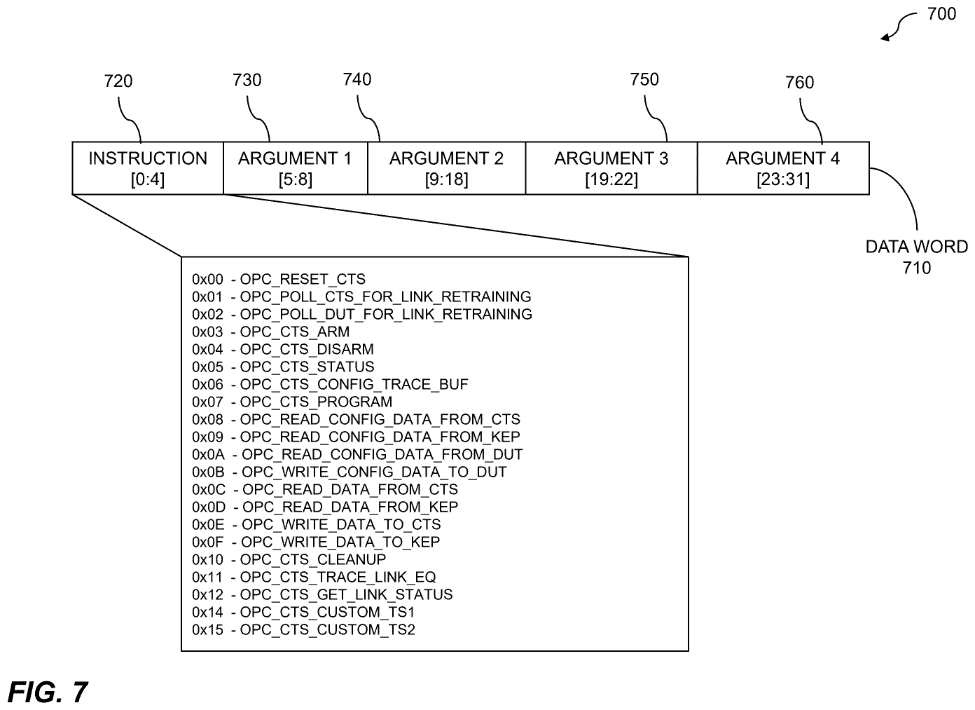

FIG. 7 is an example opcode listing for a TISA. In embodiments, the TISA comprises one or more data words. In embodiments, a first data word within the one or more data words comprises 32 bits. In the example 700, data word 710 comprises 32 bits, divided into multiple bit fields. A first bit field includes an opcode field 720. In embodiments, the opcode field comprises five bits. Additional bits can be allocated to the opcode field to provide up to 2\hat{ }N opcodes, where N is the total number of bits in the opcode field. In embodiments, the opcode field is programmable upon setup of the testing environment. Thus, based on a configuration, the number of opcode bits can be five, six, seven, or some other number of bits. The testing environment can interpret the correct number of bits as opcode bits based on the configuration. A first argument field 730 includes bits for a first argument. In embodiments, the first argument field comprises four bits. A second argument field 740 includes bits for a second argument. In embodiments, the second argument field comprises ten bits. A third argument field 750 includes bits for a third argument. In embodiments, the third argument field comprises four bits. A fourth argument field 760 includes bits for a fourth argument. In embodiments, the fourth argument field comprises nine bits.

In embodiments, the width of the first data word is programmable based upon setup of the testing environment. Thus, based on a configuration, the number of bits in the data word can be 16, 32, 64, or some other number of bits. The embodiment shown in FIG. 7 shows four argument fields, 730, 740, 750, and 760, though some embodiments may have more or fewer argument fields. Moreover, in embodiments, some opcodes may use fewer than four arguments, and some opcodes may not use any arguments. The instructions can perform a wide variety of functions for configuring and initializing test environments, as well as executing tests for a root complex and/or endpoint. As an example, the instruction 0x01,

OPC_POLL_CTS_FOR_LINK_RETRAINING, can support monitoring of the link status of a test environment after a link retrain. This instruction can cause the test environment of disclosed embodiments to periodically check the link status for retraining to complete. If the link does not successfully retrain within a specified period, this is treated as a test failure and the test is aborted. In another example, the instruction 0x02,
OPC_POLL_DUT_FOR_LINK_RETRAINING monitors a link status of a root port, after a link retrain, periodically checking the link status for retraining to complete. If the link does not successfully retrain within the specified period, it can be considered as a test failure. In another example, the instruction 0x03, OPC_CTS_ARM enables a test card to act on test conditions already programmed into it, and also enables the trace RAM. Similarly, instruction 0x04, OPC_CTS_DISARM disables the test card, and also stops trace RAM acquisition. In another example, the instruction 0x05, OPC_CTS_STATUS checks progress regarding how many of the tests have been executed. In embodiments, the instruction causes a periodic poll for intervals up to 10 milliseconds. In another example, the instruction 0x06,
OPC_CTS_CONFIG_TRACE_BUF programs a test card to capture desired traffic. In embodiments, the instruction 0x06 accepts arguments, including, but not limited to, a direction field, to indicate a direction of traffic to be captured, and a filter field, which specifies the amount of packet information that is to be captured in the given direction.

In another example, the instruction 0x07, OPC_CTS_PROGRAM programs the test system to generate a desired test condition. A variety of arguments can be used with instruction 0x07. One argument can include an action argument specifying test conditions that the test environment can generate. Another argument can refer to a type of error to be injected during a test. Another such argument can include a pattern matching argument, to specify a matching condition for a transaction layer packet and/or a data link layer packet. Other types of patterns can be matched in disclosed embodiments. In another example, the instruction 0x0C, OPC_READ_DATA_FROM_CTS reads configuration data from the test environment. The data can be a byte, word, double-word, or other suitable size. In some embodiments, an argument can be used to specify a number of bytes to read. In another example, the instruction 0x0D, OPC_READ_DATA_FROM_KEP reads configuration data from a known endpoint. The data can be a byte, word, double-word, or other suitable size. In another example, the instruction 0x0E, OPC_WRITE_DATA_TO_CTS can write configuration data to memory within the test card as referenced by a base address register (BAR). The instruction 0x0E can include one or more arguments, including, but not limited to, a byte count, a base address register identifier, a data pattern, a lower start address value, and/or an upper start address value. The aforementioned instructions are just some of the many different instructions that are possible within the TISA of disclosed embodiments.

While one data word 710 is shown in FIG. 7, in practice, there can be many data words in a test sequence. Embodiments can include a first data word, a second data word, a third data word, and so on. In embodiments, a second data word comprises 32 bits, and the second data word includes a first data pattern or a start address. In embodiments, a third data word comprises 32 bits, and the third data word includes a second data pattern, and so on.

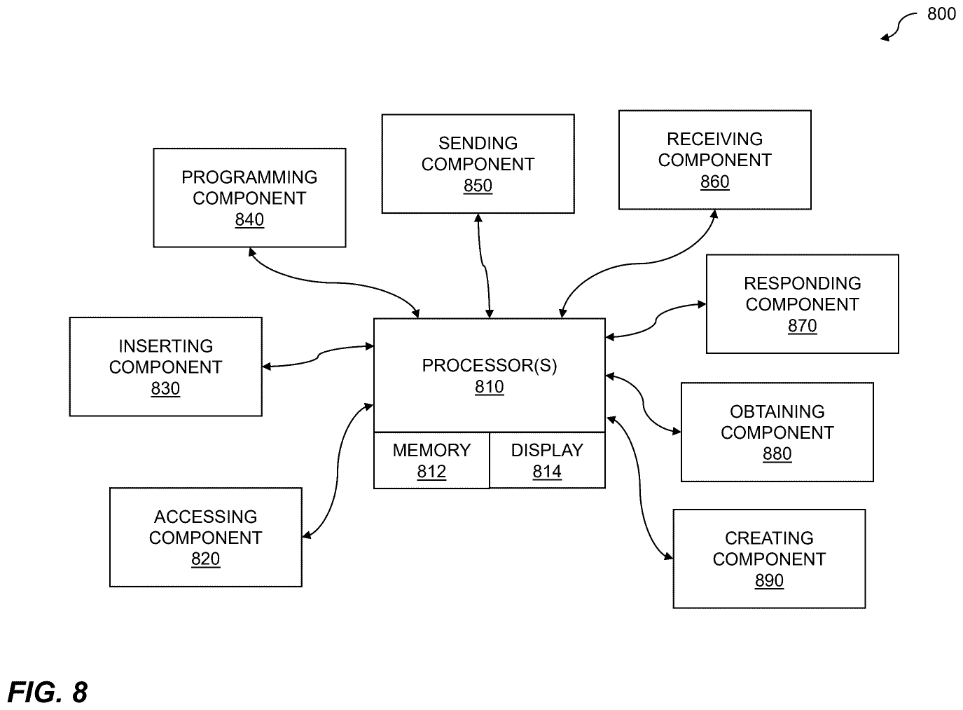

FIG. 8 is a system diagram for trace-based testing with software access points. Disclosed techniques enable and facilitate a granular access and analysis of a device under test that employs packetized communications. The system 800 comprises a system that can contain one or more processors 810 or processor cores. The one or more processors or processor cores can include processors on-chip, system-on-a-chip (SOC) processors, cores that are embedded in application specific integrated circuits (ASICs), soft processors that are implemented in an FPGA chip, and so on. The one or more processors 810 can be coupled to a memory 812. Memories can be one or more storage units such as volatile and non-volatile semiconductor memories, cache memory structures, main memory, secondary memory, and more. The one or more processors 810 can be coupled to a display 814 and other human interface devices (HIDs) such as a keyboard. HIDs can include a video display that displays operational status of system functionality, operating data, and other parameters. A video display can be used as a debug tool for displaying target device domain status, test generation software user interface (UI), test analysis software interface, and the like. The processor(s) 810, the memory 812, and the display 814 can reside in multiple and disparate networked locations, or they can reside in a single location implemented as a laptop computer, desktop computer, server computer, etc.

The system 800 includes an accessing component 820. Embodiments include accessing a testing environment, wherein the testing environment includes a target device domain, wherein the target device domain includes a trace encoder software device-under-test interface (SDI), and wherein the SDI is coupled to a device-under-test (DUT). The processor, with memory and human interface devices, can be connected to a testing environment. A testing environment can include a disparate collection of test equipment in a lab that is interconnected to perform testing using the disclosed techniques, a dedicated test system for prototype and laboratory testing, automated factory test equipment, and others. The testing environment can include significant elements, such as a trace encoder software device-under-test interface (SDI), and can ultimately be coupled to a device-under-test (DUT), which, coupled with other elements, can comprise a target device domain.

The system 800 includes an inserting component 830. Embodiments include inserting, into the SDI, a plurality of software access points, wherein the plurality of software access points allow observability, by the trace encoder, of one or more internal signals within the SDI. In embodiments, the software access points allow observability of one or more internal signals, inputs, or outputs of the SDI by means of the trace encoder. The system 800 includes a programming component 840. Embodiments include programming, by a user, the SDI with one or more modification instructions, wherein the one or more modification instructions cause the SDI to alter a response to the DUT, and wherein the one or more modification instructions are based on a test instruction set architecture (TISA). By the insertion of the software access points and the programming of modification instructions, the target device domain can be preconfigured for testing the DUT. Software access points are locations within the SDI that provide specific insight into the functionality of the interconnect protocol in use for the DUT. Modification instructions allow the target device domain, e.g., the tester, to autonomously modify the test sequence to exercise the DUT in ways that provide a view at all operational corners. Insertion of software access points and programmed modification instructions can provide a significant level of granularity for analysis and debug, assurance of industry compliance, and more.

The system 800 includes a sending component 850. Embodiments include sending, by the user, to the SDI, a test sequence, wherein the test sequence causes the SDI to send one or more communications to the DUT. The sending can be accomplished by interactive test commands entered at the user's workstation, by the exercising of a previously stored file containing a test sequence, and so on. The test sequence can consist of opcodes, commands, data, and the like, that are intended to set up and stimulate the DUT to perform in an expected manner or reveal unexpected behavior within the DUT. In embodiments, the test sequence comprises a compliance test. The system 800 includes a receiving component 860. Embodiments include receiving, by the SDI, one or more replies from the DUT, wherein the one or more replies are responsive to the test sequence. A test sequence can be generated by the user that is intended to exercise the target device domain. The target device domain logically and electronically performs as a packetized interconnect device to the DUT. The series of instructions in the test sequence causes the SDI to initiate communications to the DUT. Packetized communications to the DUT can elicit a response from the DUT. One or more responses can be received from the DUT after the test sequence is initiated. These replies can be expected or unexpected replies. Sending a test sequence to the DUT and receiving subsequent replies from the DUT can provide insight into the functionality of the DUT.

The system 800 includes a responding component 870. Embodiments include responding, by the SDI, to the one or more replies from the DUT, wherein the responding includes one or more additional communications to the DUT, and wherein the responding is based on the one or more modification instructions. In embodiments, the responding includes one or more additional communications sent autonomously to the DUT that are triggered by the modification instructions. The system 800 includes an obtaining component 880. Embodiments include obtaining, by the SDI, one or more additional replies from the DUT, wherein the one or more additional replies are responsive to the responding. As an example, in a data transaction using the PCI-E protocol, the DUT can send a data packet to the SDI. In a normal response, the SDI can send an ACK message to the DUT to acknowledge that the data packet was properly received. However, the modification instructions can instruct the SDI to instead return a NACK (negative acknowledgment) to the DUT which will tell the DUT that the data packet was not received. In this way, the modification instructions can test the DUT's reaction to unexpected functionality. Responding by sending additional communications to the DUT based on modification instructions, and obtaining the additional replies from the DUT, can provide a significantly deeper view into the behavior of the interconnected DUT.

The system 800 includes a creating component 890. Embodiments include creating, by the trace encoder, a logic trace, wherein the logic trace includes one or more states of the plurality of software access points, and wherein the creating is based on the sending, the receiving, the responding, and the obtaining. The trace encoder can convert the packetized communications from the DUT into a human-readable or computer-readable format that can be used for further understanding of the performance of the DUT. DUT performance is important to a manufacturer, to the associated industry, and to the end user. Compliance with design specifications can be important to a manufacturer to help ensure product quality and manufacturing longevity.

The system 800 can include a computer program product embodied in a non-transitory computer readable medium for testing, the computer program product comprising code which causes one or more processors to perform operations of: accessing a testing environment, wherein the testing environment includes a target device domain, wherein the target device domain includes a trace encoder software device-under-test interface (SDI), and wherein the SDI is coupled to a device-under-test (DUT); inserting, into the SDI, a plurality of software access points, wherein the plurality of software access points allow observability, by the trace encoder, of one or more internal signals within the SDI; programming, by a user, the SDI with one or more modification instructions, wherein the one or more modification instructions cause the SDI to alter a response to the DUT, and wherein the one or more modification instructions are based on a test instruction set architecture (TISA); sending, by the user to the SDI, a test sequence, wherein the test sequence causes the SDI to send one or more communications to the DUT; receiving, by the SDI, one or more replies from the DUT, wherein the one or more replies are responsive to the test sequence; responding, by the SDI, to the one or more replies from the DUT, wherein the responding includes one or more additional communications to the DUT, and wherein the responding is based on the one or more modification instructions; obtaining, by the SDI, one or more additional replies from the DUT, wherein the one or more additional replies are responsive to the responding; and creating, by the trace encoder, a logic trace, wherein the logic trace includes one or more states of the plurality of software access points, and wherein the creating is based on the sending, the receiving, the responding, and the obtaining.

The system 800 can include a computer system for testing comprising: a memory which stores instructions; one or more processors coupled to the memory wherein the one or more processors, when executing the instructions which are stored, are configured to: access a testing environment, wherein the testing environment includes a target device domain, wherein the target device domain includes a trace encoder software device-under-test interface (SDI), and wherein the SDI is coupled to a device-under-test (DUT); insert, into the SDI, a plurality of software access points, wherein the plurality of software access points allow observability, by the trace encoder, of one or more internal signals within the SDI; program, by a user, the SDI with one or more modification instructions, wherein the one or more modification instructions cause the SDI to alter a response to the DUT, and wherein the one or more modification instructions are based on a test instruction set architecture (TISA); send, by the user to the SDI, a test sequence, wherein the test sequence causes the SDI to send one or more communications to the DUT; receive, by the SDI, one or more replies from the DUT, wherein the one or more replies are responsive to the test sequence; respond, by the SDI, to the one or more replies from the DUT, wherein the responding includes one or more additional communications to the DUT, and wherein the responding is based on the one or more modification instructions; obtain, by the SDI, one or more additional replies from the DUT, wherein the one or more additional replies are responsive to the responding; and create, by the trace encoder, a logic trace, wherein the logic trace includes one or more states of the plurality of software access points, and wherein the creating is based on the sending, the receiving, the responding, and the obtaining.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

It will be appreciated that computer program instructions may include computer executable code. A variety of languages for expressing computer program instructions may include without limitation C, C++, Java, JavaScript, assembly language, Lisp, Perl, Tcl, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A processor-implemented method for testing comprising:
accessing a testing environment, wherein the testing environment includes a target device domain, wherein the target device domain includes a trace encoder software device-under-test interface (SDI), and wherein the SDI is coupled to a device-under-test (DUT);
inserting, into the SDI, a plurality of software access points, wherein the plurality of software access points allow observability, by the trace encoder, of one or more internal signals within the SDI;
programming, by a user, the SDI with one or more modification instructions, wherein the one or more modification instructions cause the SDI to alter a response to the DUT, and wherein the one or more modification instructions are based on a test instruction set architecture (TISA);
sending, by the user to the SDI, a test sequence, wherein the test sequence causes the SDI to send one or more communications to the DUT;
receiving, by the SDI, one or more replies from the DUT, wherein the one or more replies are responsive to the test sequence;
responding, by the SDI, to the one or more replies from the DUT, wherein the responding includes one or more additional communications to the DUT, and wherein the responding is based on the one or more modification instructions;
obtaining, by the SDI, one or more additional replies from the DUT, wherein the one or more additional replies are responsive to the responding; and
creating, by the trace encoder, a logic trace, wherein the logic trace includes one or more states of the plurality of software access points, and wherein the creating is based on the sending, the receiving, the responding, and the obtaining.

2. The method of claim 1 further comprising accessing, by the user, the logic trace, wherein the logic trace is stored in a trace memory.

3. The method of claim 2 further comprising comparing the logic trace to an expected logic trace.

4. The method of claim 1 further comprising setting a state of the SDI, wherein the setting is accomplished by the plurality of software access points, and wherein the setting preconditions the SDI for the responding.

5. The method of claim 1 wherein the programming comprises converting, by a code exerciser within the target device domain, the one or more modification instructions into one or more packetized communications to the SDI.

6. The method of claim 1 wherein the test sequence comprises one or more opcodes from within the TISA.

7. The method of claim 1 wherein the TISA includes one or more opcodes for control and testing of the DUT.

8. The method of claim 7 further comprising storing, in an instruction memory, the one or more modification instructions.

9. The method of claim 8 further comprising fetching, by a fetch and decode unit, the one or more modification instructions, wherein the fetching includes decoding the one or more modification instructions.

10. The method of claim 1 wherein the logic trace comprises one or more 64-bit words.

11. The method of claim 1 wherein the logic trace includes a count, wherein the count records a number of times a same packetized communication occurred between the SDI and the DUT.

12. The method of claim 1 wherein the SDI includes a PCI-Express (PCI-E) controller.

13. The method of claim 12 wherein the PCI-express controller comprises a PCI-E root complex.

14. The method of claim 13 wherein the DUT comprises a PCI-E endpoint device.

15. The method of claim 12 wherein the PCI-express controller comprises a PCI-E endpoint device.

16. The method of claim 15 wherein the DUT comprises a PCI-E root complex.

17. The method of claim 1 wherein the SDI includes a CXL controller.

18. The method of claim 17 wherein the DUT comprises a CXL controller.

19. The method of claim 1 wherein the SDI includes an ethernet controller.

20. The method of claim 19 wherein the DUT comprises an ethernet controller.

21. The method of claim 1 wherein the SDI includes a USB controller.

22. The method of claim 21 wherein the DUT comprises a USB controller.

23. The method of claim 1 wherein the logic trace includes one or more inputs and/or outputs to the SDI.

24. The method of claim 1 wherein the test sequence comprises a compliance test.

25. A computer program product embodied in a non-transitory computer readable medium for testing, the computer program product comprising code which causes one or more processors to perform operations of:
accessing a testing environment, wherein the testing environment includes a target device domain, wherein the target device domain includes a trace encoder software device-under-test interface (SDI), and wherein the SDI is coupled to a device-under-test (DUT);
inserting, into the SDI, a plurality of software access points, wherein the plurality of software access points allow observability, by the trace encoder, of one or more internal signals within the SDI;
programming, by a user, the SDI with one or more modification instructions, wherein the one or more modification instructions cause the SDI to alter a response to the DUT, and wherein the one or more modification instructions are based on a test instruction set architecture (TISA);
sending, by the user to the SDI, a test sequence, wherein the test sequence causes the SDI to send one or more communications to the DUT;
receiving, by the SDI, one or more replies from the DUT, wherein the one or more replies are responsive to the test sequence;
responding, by the SDI, to the one or more replies from the DUT, wherein the responding includes one or more additional communications to the DUT, and wherein the responding is based on the one or more modification instructions;
obtaining, by the SDI, one or more additional replies from the DUT, wherein the one or more additional replies are responsive to the responding; and
creating, by the trace encoder, a logic trace, wherein the logic trace includes one or more states of the plurality of software access points, and wherein the creating is based on the sending, the receiving, the responding, and the obtaining.

26. A computer system for testing comprising:
a memory which stores instructions;
one or more processors coupled to the memory wherein the one or more processors, when executing the instructions which are stored, are configured to:
access a testing environment, wherein the testing environment includes a target device domain, wherein the target device domain includes a trace encoder software device-under-test interface (SDI), and wherein the SDI is coupled to a device-under-test (DUT);
insert, into the SDI, a plurality of software access points, wherein the plurality of software access points allow observability, by the trace encoder, of one or more internal signals within the SDI;
program, by a user, the SDI with one or more modification instructions, wherein the one or more modification instructions cause the SDI to alter a response to the DUT, and wherein the one or more modification instructions are based on a test instruction set architecture (TISA);
send, by the user to the SDI, a test sequence, wherein the test sequence causes the SDI to send one or more communications to the DUT;
receive, by the SDI, one or more replies from the DUT, wherein the one or more replies are responsive to the test sequence;
respond, by the SDI, to the one or more replies from the DUT, wherein the responding includes one or more additional communications to the DUT, and wherein the responding is based on the one or more modification instructions;
obtain, by the SDI, one or more additional replies from the DUT, wherein the one or more additional replies are responsive to the responding; and
create, by the trace encoder, a logic trace, wherein the logic trace includes one or more states of the plurality of software access points, and wherein the creating is based on the sending, the receiving, the responding, and the obtaining.
